(19) United States
(12) Patent Application Publication
(10) Pub. No.: US 2023/0267316 A1
(43) Pub. Date: Aug. 24, 2023

(54) INFERENCE METHOD, TRAINING METHOD, INFERENCE DEVICE, TRAINING DEVICE, AND PROGRAM

(71) Applicant: NIPPON TELEGRAPH AND TELEPHONE CORPORATION, Tokyo (JP)

(72) Inventors: Sekitoshi KANAI, Musashino-shi, Tokyo (JP); Masanori YAMADA, Musashino-shi, Tokyo (JP)

(73) Assignee: NIPPON TELEGRAPH AND TELEPHONE CORPORATION, Tokyo (JP)

(21) Appl. No.: 18/015,330

(22) PCT Filed: Aug. 5, 2020
(86) PCT No.: PCT/JP2020/030097

§ 371 Date: Jan. 10, 2023

(51) Int. Cl. G06N 3/048

(52) U.S. Cl. CPC G06N 3/048

(57) ABSTRACT

An inference device executes a first conversion step of converting an output from an intermediate layer using a bounded nonlinear function in a final layer of a deep neural network having the intermediate layer and the final layer. Moreover, the inference device executes a second conversion step of converting a value obtained by conversion in the first conversion step using an activation function.

### TECHNICAL FIELD

The present invention relates to an inference method, a learning method, an inference device, a learning device, and a program.

### BACKGROUND ART

Conventionally, deep learning and deep neural networks have achieved great success in image recognition, voice recognition, and the like. For example, in image recognition using deep learning, when an image is inputted to a model including many nonlinear functions of deep learning, an identification result of what the image shows is outputted. In particular, convolutional networks and ReLUs are commonly used in image recognition. In the following description, a deep neural network trained by deep learning may be simply referred to as a deep learning model or a model.

On the other hand, if a malicious attacker adds noise to an input image, the deep learning model can be easily misidentified with small noise (e.g., refer to Non Patent Literature 1). This is called an adversarial attack, and attack methods such as a projected gradient descent (PGD) are known (e.g., refer to Non Patent Literature 2). In contrast, as a method for making a model robust, a method called logit squeezing for constraining the norm of a vector (logit) immediately before output of the model has been proposed (e.g., refer to Non Patent Literature 3).

### CITATION LIST

### Non Patent Literature

Non Patent Literature 1: Christian Szegedy, et al. “Intriguing properties of neural networks.” arXiv preprint: 1312.6199, 2013.
Non Patent Literature 2: Madry Aleksander, et al. “Towards deep learning models resistant to adversarial attacks.” arXiv preprint: 1706.06083, 2017.
Non Patent Literature 3: Kannan Harini, Alexey Kurakin, and Ian Goodfellow. “Adversarial logit pairing.” arXiv preprint:1803.06373 (2018).

### SUMMARY OF INVENTION

### Technical Problem

However, a conventional deep learning model has a problem that it may not be robust against noise. In logit squeezing described in Non Patent Literature 3, for example, robustness may not be sufficiently improved.

### Solution to Problem

In order to solve the above-described problems and achieve the object, an inference method executed by an inference device is characterized by including: a first conversion step of converting an output from an intermediate layer using a bounded nonlinear function in a final layer of a deep neural network having the intermediate layer and the final layer; and a second conversion step of converting a value obtained by conversion in the first conversion step using an activation function.

### Advantageous Effects of Invention

According to the present invention, the deep learning model can be made robust against noise.

### BRIEF DESCRIPTION OF DRAWINGS

FIG. 1 is a diagram illustrating a structure of an entire deep learning model.

FIG. 2 is a diagram illustrating a configuration example of a learning device according to a first embodiment.

FIG. 3 is a diagram illustrating a structure of a final layer of a deep learning model.

FIG. 4 is a diagram illustrating a configuration example of an inference device according to the first embodiment.

FIG. 5 is a flowchart illustrating a flow of processing of a learning device according to the first embodiment.

FIG. 6 is a flowchart illustrating a flow of processing of an inference device according to the first embodiment.

FIG. 7 is a diagram illustrating an example of a computer that executes a program.

### DESCRIPTION OF EMBODIMENTS

[Conventional Deep Learning Model and Logit Squeezing]

First, a conventional deep learning model and logit squeezing will be described. Here, as an example, it is assumed that the deep learning model is a model for image recognition. It is assumed that image recognition is a problem of recognizing a signal x∈R^{c×H×W} of an inputted image and obtaining a label y of the image from M labels. Here, C is a channel of an image (three channels in the case of RGB format), and H and W are respectively vertical and horizontal sizes (the number of pixels) of the image. Moreover, it is assumed that capital letters in bold in the following formulas each represent a matrix, small letters in bold each represent a column vector, and a row vector is represented using transposition.

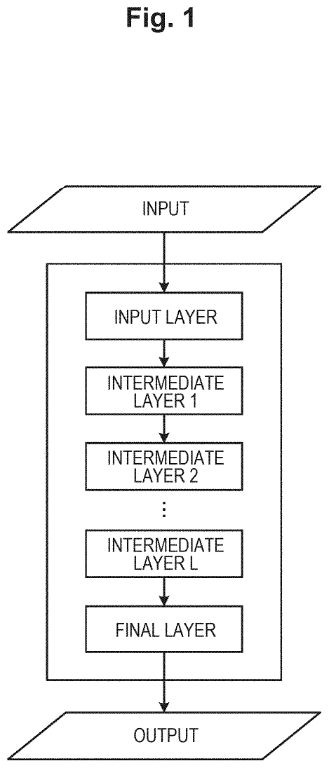

FIG. 1 is a diagram illustrating a structure of an entire deep learning model. As illustrated in FIG. 1, the deep learning model is a deep neural network having an input layer, one or more intermediate layers, and a final layer. In the example in FIG. 1, the deep learning model has L intermediate layers.

The input layer accepts an input of a signal. Each intermediate layer further converts and outputs an output from the input layer or an output from the previous intermediate layer. The final layer further converts and outputs an output from the intermediate layer. An output from the final layer is an output of the entire deep learning model, for example, a probability.

Here, an output of the L-th intermediate layer is expressed in Formula (1). Here, θ is a parameter of the deep learning model. Moreover, z_{θ}(x) is a logit.

[Math. 1]

z_{θ}=[z_{θ,1}(x),z_{θ,2}(x), . . . ,z_{θ,M}(x)]^{T} (1)

Assuming that the softmax function is fₛ(·), the output of the deep learning model is an output fₛ(z_{θ}(x))ε R^{M} of the softmax function, and the output of the k-th element is expressed as in Formula (2).

$$[ Math . 2 ]$$

$${[ {f}_{s} ( {z}_{θ} ( x ) ) ]}_{k} = \frac{exp ( {z}_{θ , k} ( x ) )}{{\sum }_{m = 1}^{M} ( {z}_{θ , m} ( x ) )} \qquad ( 2 )$$

The output expressed in Formula (2) represents the score for each label in classification. Furthermore, the element ∧yᵢ (∧ immediately above y) having the largest score among the elements of the final layer as expressed in Formula (3) is the result of the classification.

$$[ Math . 3 ]$$

$${\hat{y}}_{i} = arg {{max}_{k} [ {f}_{s} ( {z}_{θ} ( x ) ) ]}_{k} \qquad ( 3 )$$

Image recognition is one of classification, and a model fₛ(z_{θ}(·)) for performing classification is referred to as a classifier or a discriminator. Moreover, the parameter θ is determined by learning. The learning is performed using, for example, N data sets {(xᵢ, yᵢ)}, i=1, . . . , N prepared in advance. Here, xᵢ is data indicating a characteristic such as a signal of an image, and yᵢ is a correct answer label.

The learning is performed so that the deep model outputs the highest score of the element corresponding to the correct answer label, that is, so that Formula (4) is satisfied.

$$[ Math . 4 ]$$

$${y}_{i} = arg {{max}_{k} [ {f}_{s} ( {z}_{θ} ( x ) ) ]}_{k} \qquad ( 4 )$$

Specifically, a loss function L(x, y, θ) such as the cross entropy is optimized as in Formula (5) in the learning. In other words, the parameter θ is updated so that Formula (5) is satisfied.

$$[ Math . 5 ]$$

$$θ = arg {min}_{θ} {\sum }_{i = 1}^{N} L ( {x}_{i} , {y}_{i} , θ ) \qquad ( 5 )$$

Here, the conventional deep learning model has vulnerability, and may be misrecognized due to an adversarial attack. The adversarial attack is formulated with an optimization problem of Formula (6).

$$[ Math . 6 ]$$

$$δ = arg {min}_{δ} {‖ δ ‖}_{p} \\ subject to {y}_{i} \neq arg {{max}_{k} [ {f}_{s} ( {z}_{θ} ( x ) ) ]}_{k} \qquad ( 6 )$$

∥•∥ₚ is an lₚ norm, and p=2, p=∞, and the like are mainly used. The optimization problem of Formula (5) is a problem of obtaining noise with the smallest norm that is misrecognized, and an attack method that uses a gradient of a model such as a fast gradient sign method (FGSM) and a PGD is known. Note that, the smaller the norm of the noise is, the more natural the recognition result is felt, and an attack is less likely to be detected.

On the other hand, as described above, logit squeezing for suppressing the norm of a logit has been proposed as a method of defense against an adversarial attack on a deep learning model. In logit squeezing, an objective function such as Formula (7) is used at the time of learning.

$$[ Math . 7 ]$$

$$θ = arg {min}_{θ} {\sum }_{i = 1}^{N} L ( {x}_{i} , {y}_{i} , θ ) + λ {‖ {z}_{θ} ( {x}_{i} ) ‖}_{2}^{2} \qquad ( 7 )$$

The objective function of Formula (7) can be said to be a function obtained by adding the norm of a logit to the objective function expressed in Formula (5). Moreover, X is an adjustable parameter determined by trial and error.

According to logit squeezing, the norm of the output fₛ(z_{θ}(x)) of the softmax function can be suppressed. On the other hand, in logit squeezing, the robustness of a deep learning model may not be sufficiently improved.

### First Embodiment

Hereinafter, an embodiments of an inference method, a learning method, an inference device, a learning device, and a program according to the present application will be described in detail with reference to the drawings. Note that the present invention is not limited to the embodiment described below.

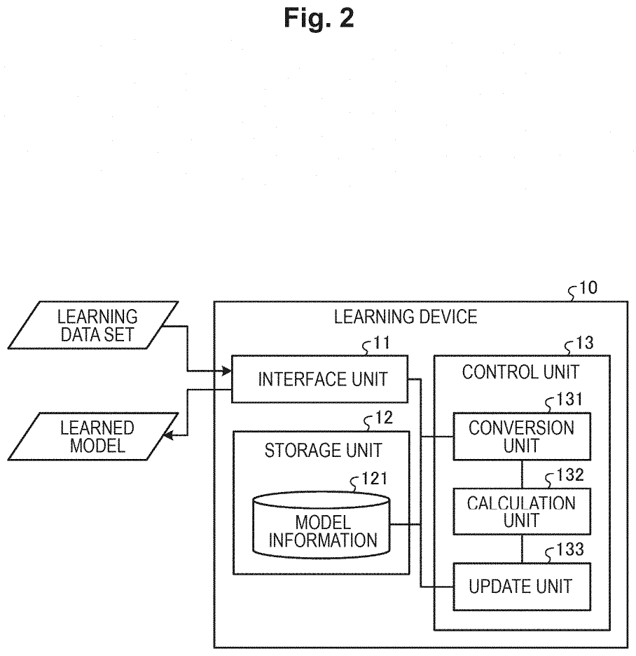

First, a configuration of a learning device according to the first embodiment will be described with reference to FIG. 2. FIG. 2 is a diagram illustrating a configuration example of the learning device according to the first embodiment. As illustrated in FIG. 2, a learning device 10 accepts an input of a learning data set, learns a model, and outputs a learned model.

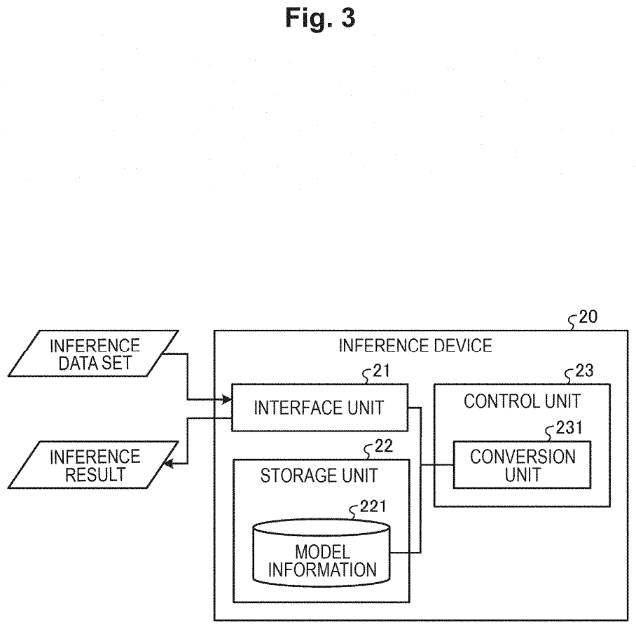

Here, units of the learning device 10 will be described. As illustrated in FIG. 2, the learning device 10 has an interface unit 11, a storage unit 12, and a control unit 13. Note that an inference device 20 to be described later has components similar to those of the learning device 10 as illustrated in FIG. 3. That is, the inference device 20 has an interface unit 21, a storage unit 22, and a control unit 23. Moreover, the learning device 10 may have a function equivalent to that of the inference device 20, and perform inference processing.

Referring back to FIG. 2, the interface unit 11 is an interface for inputting and outputting data. For example, the interface unit 11 includes a network interface card (NIC). Moreover, the interface unit 11 may include an input device such as a mouse or a keyboard, and an output device such as a display.

The storage unit 12 is a storage device such as a hard disk drive (HDD), a solid state drive (SSD), or an optical disk. Note that the storage unit 12 may be a data-rewritable semiconductor memory such as a random access memory (RAM), a flash memory, or a non-volatile static random access memory (NVSRAM). The storage unit 12 stores an operating system (OS) and various programs to be executed by the learning device 10. Moreover, the storage unit 12 stores model information 121.

The model information 121 is information such as parameters for constructing a deep learning model. For example, the model information 121 includes the weight, bias, and the like of each layer of the deep neural network. Moreover, the deep learning model constructed by the model information 121 may be a learned model or an unlearned model.

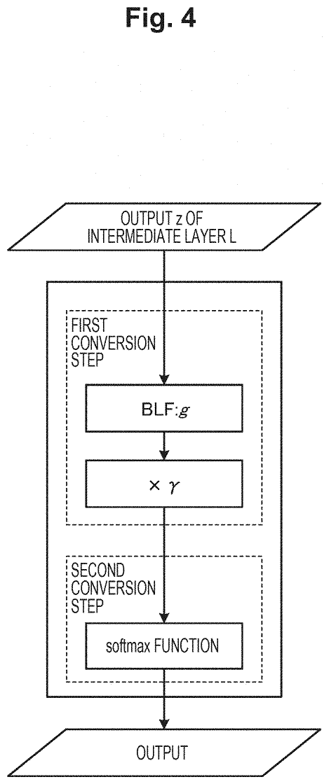

The deep learning model of the present embodiment is different from the above-described conventional deep learning model in the structure of the final layer. FIG. 4 is a diagram illustrating a structure of the final layer of a deep learning model. As illustrated in FIG. 4, in the final layer of the present embodiment, a first conversion step and a second conversion step are executed. In the first conversion step, conversion using g(·), which is a bounded logit function (BLF, nonlinear function), and a coefficient γ is performed. Moreover, in the second conversion step, conversion by the softmax function is performed. Details of each conversion step will be described later.

The control unit 13 controls the entire learning device 10. The control unit 13 is, for example, an electronic circuit such as a central processing unit (CPU) or a micro processing unit (MPU), or an integrated circuit such as an application specific integrated circuit (ASIC) or a field programmable gate array (FPGA). Moreover, the control unit 13 has an internal memory for storing programs and control data defining various processing procedures, and executes each processing using the internal memory. Moreover, the control unit 13 functions as various processing units by operation of various programs. For example, the control unit 13 has a conversion unit 131, a calculation unit 132, and an update unit 133.

The conversion unit 131 repeats a nonlinear function and a linear operation on an image signal inputted to the input layer in each intermediate layer. Then, the conversion unit 131 executes the first conversion step and the second conversion step in the final layer.

The conversion unit 131 executes the first conversion step on the output of the intermediate layer. The first conversion step is a step in which the conversion unit 131 converts the output from the intermediate layer using a bounded nonlinear function in the final layer of the deep learning model. In the first conversion step, the conversion unit 131 inputs the output from the L-th intermediate layer to the function g(·), and further multiplies the output of the function g(·) by a coefficient γ.

Specifically, in the first conversion step, the conversion unit 131 converts z, which is a logit outputted from the intermediate layer, using a nonlinear function g(·) as expressed in Formula (8). Here, σ(·) is a sigmoid function. Moreover, z is an argument inputted to the nonlinear function g(·), and corresponds to, for example, the output z_{θ}(x) of the L-th intermediate layer.

[Math. 8]

g(z)=2{zσ(z)+σ(z)−zσ²(z)}−1 (8)

Furthermore, in the first conversion step, the conversion unit 131 performs conversion by multiplying the output of the nonlinear function by a parameter γ (where 0<γ<∞) determined by trial and error.

Here, Formula (9) is satisfied according to Formula (8). As expressed in Formula (9), the maximum value of the absolute value of γg(z), which is an output of the first conversion step, falls within a range between two constants that are not infinite. Moreover, an output of the first conversion process is an input to the softmax function that is the second conversion step, that is, a logit.

Therefore, in the present embodiment, the logit is maintained at a bounded value.

$$[ Math . 9 ]$$

$$γ < {max}_{z} \vert γ g ( z ) \vert < γ \frac{\sqrt{5} + 1}{2} \qquad ( 9 )$$

Furthermore, since Formula (10) is satisfied, yg(z), which is an output of the first conversion step, that is, the value of z when the logit takes the maximum value falls within a range between two constants which are not infinite. Therefore, in the present embodiment, the output of the intermediate layer when the logit takes the maximum value is maintained at a bounded value.

$$[ Math . 10 ]$$

$$2 < \vert arg {max}_{z} γ g ( z ) \vert < \sqrt{5} + 1 \qquad ( 10 )$$

As described above, the conversion unit 131 performs conversion using a nonlinear function in which the maximum value of the absolute value is not infinite and the value of the argument when taking the maximum value is not infinite. Therefore, according to the present embodiment, the logit is bounded and the output of the intermediate layer in a case where the logit takes the maximum value is also bounded, and thus, the deep learning model becomes more robust against an adversarial attack.

The softmax function is an example of an activation function. In the second conversion step, the conversion unit 131 executes a second conversion step of converting the value obtained by conversion in the first conversion step using an activation function. The output of the second conversion step in the present embodiment is represented by Formula (11) obtained by modifying Formula (2).

$$[ Math . 11 ]$$

$${[ {f}_{s} ( g ( {z}_{θ} ( x ) ) ) ]}_{k} = \frac{exp ( g ( {z}_{θ , k} ( x ) ) )}{{\sum }_{m = 1}^{M} ( g ( {z}_{θ , m} ( x ) ) )} \qquad ( 11 )$$

Moreover, in the present embodiment, the element ∧yᵢ having the largest score among the elements of the final layer is expressed as in Formula (12).

$$[ Math . 12 ]$$

$${\hat{y}}_{i} = arg {{max}_{k} [ {f}_{s} ( g ( {z}_{θ} ( x ) ) ) ]}_{k} \qquad ( 12 )$$

The calculation unit 132 calculates a loss function L(xᵢ, yᵢ, θ). Moreover, the learning is performed so that Formula (13) is satisfied.

$$[ Math . 13 ]$$

$${y}_{i} = arg {{max}_{k} [ {f}_{s} ( g ( {z}_{θ} ( x ) ) ) ]}_{k} \qquad ( 13 )$$

The update unit 133 updates the parameter of the deep neural network so that the objective function based on the value obtained by conversion in the second conversion step is optimized. For example, the update unit 133 optimizes the loss function L(x, y, θ) such as the cross entropy as in Formula (5). The update unit 133 updates the model information 121.

Next, a configuration of the inference device according to the first embodiment will be described with reference to FIG. 3. FIG. 3 is a diagram illustrating a configuration example of the inference device according to the first embodiment. As illustrated in FIG. 3, the inference device 20 accepts an input of an inference data set and outputs an inference result obtained by performing the inference processing.

Here, units of the inference device 20 will be described. As illustrated in FIG. 3, the inference device 20 has the interface unit 21, the storage unit 22, and the control unit 23. The interface unit 21, the storage unit 22, and the control unit 23 have functions similar to those of the interface unit 11, the storage unit 12, and the control unit 13 of the learning device 10.

Model information 221 is data equivalent to the updated model information 121 in the learning device 10. Moreover, a conversion unit 231 executes the first conversion step and the second conversion step similarly to the conversion unit 131. Here, since the label in the inference data set is unknown, the inference device 20 receives the data xᵢ indicating the characteristic as an input, and outputs the label yᵢ obtained as in Formula (4).

[Processing of First Embodiment]

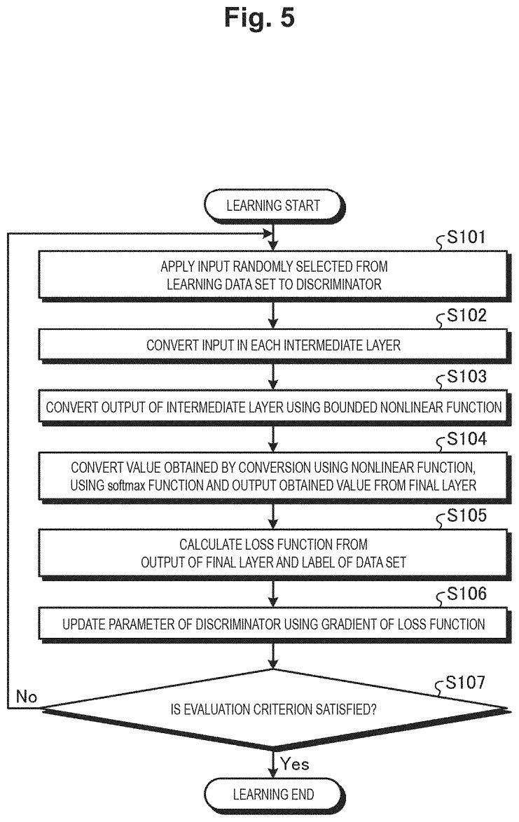

FIG. 5 is a flowchart illustrating a flow of processing of the learning device according to the first embodiment. As illustrated in FIG. 5, the conversion unit 131 applies an input randomly selected from the data set to the discriminator (step S101). For example, the conversion unit 131 inputs a signal x of the image included in the data set to the deep learning model. Next, the conversion unit 131 converts the input in each intermediate layer (step S102).

Here, the conversion unit 131 converts the output of the intermediate layer using a bounded nonlinear function (step S103). For example, the conversion unit 131 performs conversion using Formula (8). Furthermore, the conversion unit 131 may multiply the conversion result of Formula (8) by the parameter γ. Step S103 corresponds to the first conversion step.

Furthermore, the conversion unit 131 converts the value obtained by conversion using the nonlinear function, using a softmax function, and outputs the obtained value from the final layer (step S104). Step S104 corresponds to the second conversion step.

The calculation unit 132 calculates a loss function from the output of the final layer obtained in step S10 and the label of the data set (step S105). Then, the update unit 133 updates the parameter of the discriminator using the gradient of the loss function (step S106). In a case where an evaluation criterion is not satisfied (step S107, No), the learning device 10 returns to step S101 and repeats the processing. In a case where the evaluation criterion is satisfied (step S107, Yes), the learning device 10 terminates the processing. The evaluation criterion is that the processing from steps S101 to S106 is repeated a certain number of times or more, the update width of the parameter in step S106 becomes equal to or less than a threshold, and the like.

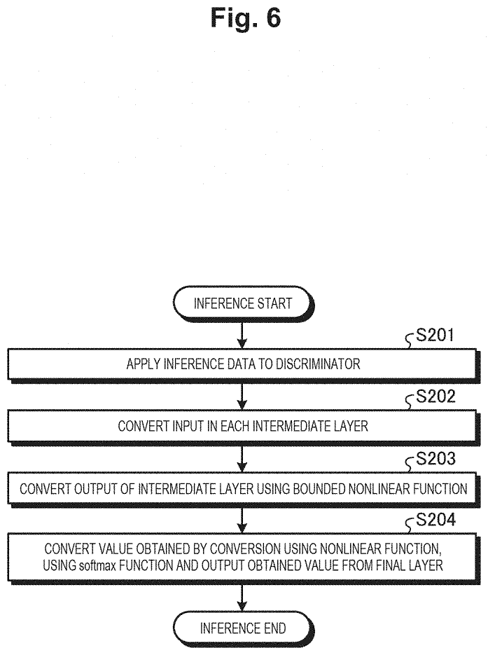

FIG. 6 is a flowchart illustrating a flow of processing of the inference device according to the first embodiment. As illustrated in FIG. 6, the conversion unit 231 applies inference data to the discriminator (step S201). For example, the conversion unit 131 inputs the signal x of the image to the deep learning model. Next, the conversion unit 231 converts the input in each intermediate layer (step S202).

Here, the conversion unit 231 converts the output of the intermediate layer using a bounded nonlinear function (step S203). For example, the conversion unit 231 performs conversion using Formula (8). Furthermore, the conversion unit 231 may multiply the conversion result of Formula (8) by the parameter γ.

Furthermore, the conversion unit 231 converts the value obtained by conversion using the nonlinear function, using the softmax function, and outputs the obtained value from the final layer (step S204). For example, the output from the final layer is a score (probability) for each label. The inference device 20 may output the score for each label obtained in step S204 as it is, or may output information for specifying a label having the maximum score.

### Effects of First Embodiment

As described above, the conversion unit 231 executes the first conversion step of converting the output from the intermediate layer using the bounded nonlinear function in the final layer of the deep neural network having the intermediate layer and the final layer. The conversion unit 231 executes the second conversion step of converting the value obtained by conversion in the first conversion step using the activation function. Therefore, the norm of the logit inputted to the activation function is suppressed, and the logit becomes bounded. As a result, according to the present embodiment, the deep learning model becomes robust against noise.

The conversion unit 131 performs conversion using a nonlinear function in which the maximum value of the absolute value is not infinite and the value of the argument when taking the maximum value is not infinite. Therefore, not only the output of the nonlinear function but also the input is bounded, and thus, the deep learning model is more robust against noise.

Here, each of sigmoid and tanh is a function that is bounded but monotonically increases. On the other hand, g(·), which is the BLF of the present embodiment, is a bounded nonlinear function in which the maximum value of the absolute value is not infinite and the value of the argument that takes the maximum value is not infinite. Thus, according to the present embodiment, the robustness of the deep learning model can be further improved by reducing not only the norm of the output of the softmax function but also the norm of the input.

In the first conversion step, the conversion unit 231 performs conversion by multiplying the output of the nonlinear function by the parameter γ (where 0<γ<∞) determined by trial and error. Therefore, the robustness of the deep learning model can be adjusted.

The conversion unit 131 executes the first conversion step of converting the output from the intermediate layer using a bounded nonlinear function in the final layer of the deep neural network having the intermediate layer and the final layer. The conversion unit 131 executes the second conversion step of converting the value obtained by conversion in the first conversion step using the activation function. The update unit 133 updates the parameter of the deep neural network so that the objective function based on the value obtained by conversion in the second conversion step is optimized. Therefore, the deep learning model with improved robustness can be learned.

[System Configuration Etc.]

Moreover, each component of each illustrated device is functionally conceptual, and does not necessarily need to be physically configured as illustrated. That is, a specific form of distribution and integration of devices is not limited to the illustrated form, and all or a part thereof can be functionally or physically distributed or integrated in any unit according to various loads, usage conditions, and the like. Furthermore, all or an arbitrary part of each processing function performed in each device can be implemented by a central processing unit (CPU) and a program analyzed and executed by the CPU, or can be implemented as hardware by wired logic.

Moreover, all or some of the processes described as being performed automatically among the processes described in the present embodiment can be performed manually, or all or some of the processes described as being performed manually can be performed automatically by a known method. In addition, the processing procedures, the control procedures, the specific names, and the information including various data and parameters illustrated in the specification and the drawings can be arbitrarily changed unless otherwise specified.

[Program]

As an embodiment, the learning device 10 and the inference device 20 can be implemented by causing a desired computer to install a program for executing the learning processing or the inference processing as package software or online software. For example, it is possible to cause an information processing device to function as the learning device 10 or the inference device 20 by causing the information processing device to execute the above program. The information processing device mentioned here includes a desktop or notebook personal computer.

Moreover, the category of an information processing device also includes a mobile communication terminal such as a smartphone, a mobile phone, and a personal handyphone system (PHS), a slate terminal such as a personal digital assistant (PDA), and the like.

Moreover, the learning device 10 and the inference device 20 can be implemented as a server device that sets a terminal device used by a user as a client and provides a service related to the above processing to the client. For example, the server device is implemented as a server device that provides a service having a data set as an input and a learned deep learning model as an output. In this case, the server device may be implemented as a Web server, or may be implemented as a cloud that provides a service related to the above processing by outsourcing.

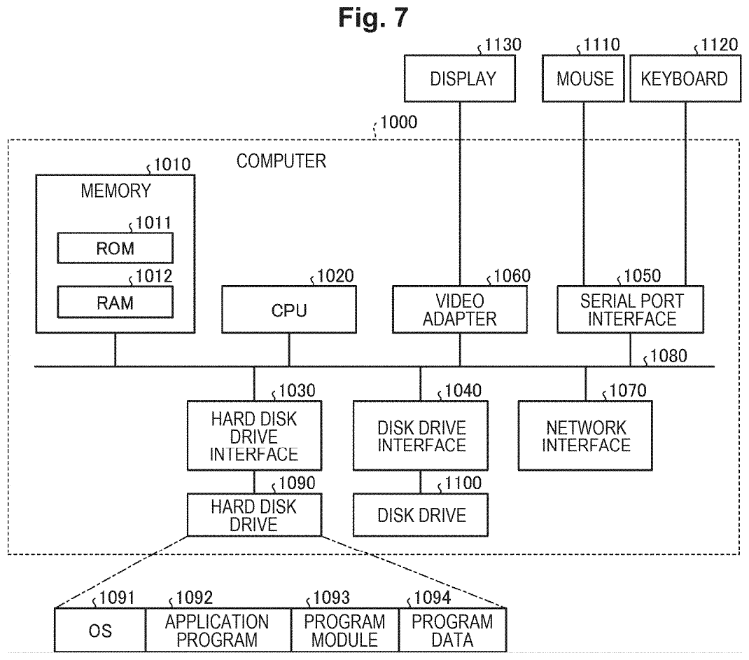

FIG. 7 is a diagram illustrating an example of a computer that executes a program. A computer 1000 has, for example, a memory 1010 and a CPU 1020. Moreover, the computer 1000 has a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected with a hard disk drive 1090. The disk drive interface 1040 is connected with a disk drive 1100. For example, a detachable recording medium such as a magnetic disk or an optical disk is inserted into the disk drive 1100. The serial port interface 1050 is connected with, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. That is, the program that defines each processing of the learning device 10 and the inference device 20 is implemented as the program module 1093 in which codes executable by a computer are described. The program module 1093 is stored in, for example, the hard disk drive 1090. For example, the program module 1093 for executing processing similar to the functional configuration in the learning device 10 and the inference device 20 is stored in the hard disk drive 1090. Note that the hard disk drive 1090 may be replaced with a solid state drive (SSD).

Moreover, the setting data used in the processing of the above-described embodiment is stored in, for example, the memory 1010 or the hard disk drive 1090 as the program data 1094. Then, the CPU 1020 reads the program module 1093 and the program data 1094 stored in the memory 1010 and the hard disk drive 1090 to the RAM 1012 as necessary, and executes the processing of the above-described embodiment.

Note that the program module 1093 and the program data 1094 are not limited to being stored in the hard disk drive 1090, and may be stored in, for example, a detachable recording medium and read by the CPU 1020 via the disk drive 1100 or the like. Alternatively, the program module 1093 and the program data 1094 may be stored in another computer connected via a network (local area network (LAN), wide area network (WAN), etc.). Then, the program module 1093 and the program data 1094 may be read by the CPU 1020 from another computer via the network interface 1070.

### REFERENCE SIGNS LIST

Learning Device
Inference Device
11, 21 Interface Unit
12, 22 Storage Unit
13, 23 Control Unit
121, 221 Model Information
131, 231 Conversion Unit
132 Calculation Unit
133 Update Unit

1. An inference method executed by an inference device, the method comprising:
a first conversion step of converting an output from an intermediate layer using a bounded nonlinear function in a final layer of a deep neural network having the intermediate layer and the final layer; and
a second conversion step of converting a value obtained by conversion in the first conversion step using an activation function.

2. The inference method according to claim 1, wherein conversion in the first conversion step is performed using a nonlinear function in which a maximum value of an absolute value is not infinite and a value of an argument when taking a maximum value is not infinite.

3. The inference method according to claim 1, wherein conversion in the first conversion step is performed by multiplying an output of the nonlinear function by a parameter γ (where 0<γ<∞) determined by trial and error.

4. A learning method executed by a learning device, the method comprising:
a first conversion step of converting an output from an intermediate layer using a bounded nonlinear function in a final layer of a deep neural network having the intermediate layer and the final layer;
a second conversion step of converting a value obtained by conversion in the first conversion step using an activation function; and
an update step of updating a parameter of the deep neural network so that an objective function based on a value obtained by conversion in the second conversion step is optimized.

5. An inference device comprising conversion circuitry configured to perform:
a first conversion to convert an output from an intermediate layer using a bounded nonlinear function in a final layer of a deep neural network having the intermediate layer and the final layer; and
a second conversion to convert a value obtained by conversion in the first conversion using an activation function.

6. A learning device comprising:
conversion circuitry configured to perform a first conversion to convert an output from an intermediate layer using a bounded nonlinear function in a final layer of a deep neural network having the intermediate layer and the final layer, and a second conversion to convert a value obtained by conversion in the first conversion step using an activation function; and
update circuitry configured to update a parameter of the deep neural network so that an objective function based on a value obtained by conversion in the second conversion is optimized.

7. A non-transitory computer readable medium including a program for causing a computer to function as the inference device according to claim 5.

8. A non-transitory computer readable medium including a program for causing a computer to function as the learning device according to claim 6.

9. A non-transitory computer readable medium including a program for causing a computer to perform the method of claim 4.
